(19) United States
(12) Patent Application Publication
(10) Pub. No.: US 2008/0018723 A1
(43) Pub. Date: Jan. 24, 2008

(54) Control device for inkjet printing machine

(75) Inventor: Chih-Hua Yen, Hsi Chih City (TW)

Correspondence Address: TROXELL LAW OFFICE PLLC;SUITE 1404, 5205 LEESBURG PIKE, FALLS CHURCH, VA, 22041, US

(73) Assignee: Great Computer Corporation

(21) Appl. No.: 11/488,736

(22) Filed: Jul. 19, 2006

(51) Int. Cl. B41J 2/01

(52) U.S. Cl. 347/101

(57) ABSTRACT

An inkjet printing machine includes a main body which has a work surface and at least a control device. Two pressing rods are movably located above the work surface. An alignment rod is movably located a center of the work surface. A suction device is located beneath the work surface and including holes which communicate through the work surface. The control device is electrically connected to the pressing rods, the alignment rod and the suction device.

### FIELD OF THE INVENTION

The present invention relates to an inkjet printing machine with a main body and a control device, more particularly to a structure with two control treadles at front and rear ends of the printing machine, such that the user can operate the inkjet printing machine directly.

### BACKGROUND OF THE INVENTION

A conventional large inkjet printing machine generally includes a guiding device for guiding the object to be printed such as a paper sheet in the printing machine. The guiding device includes a pressing rod, an alignment rod and a suction device. The paper sheet is fed by rollers toward the printing heads and the pressing rod provides a flexible pressing force to position the paper sheet when moving forward. The alignment rod provides an alignment for the paper sheet and the suction device provides a vacuum suction force to suck the paper sheet on the surface so as to be printed as expected.

When changing the paper sheet, the user has to go to the computer to send commands by mouse or keyboard to stop the suction device, to raise the pressing rod and to lower the alignment rod, and the user goes to the machine to remove the paper sheet from the machine or to put a new paper sheet to the machine. After the paper sheet is in position, the user then go to the computer again to input commands to pint the paper sheet. This wastes a lot of time between the computer and the inkjet printing machine.

The present invention intends to provide an inkjet printing machine which includes two control devices which are able to send commands to the suction device, the pressing rods, and the alignment rod so that the user needs not to move back and forth between the inkjet printing machine and the computer.

### SUMMARY OF THE INVENTION

The present invention relates to an inkjet printing machine which includes a main body and at least a control device. The main body is with a work surface. Two pressing rods are movably located above the work surface, an alignment rod is movably located a center of the work surface, and a suction device is located beneath the work surface and includes holes defined through the work surface. The control device is connected to the main body and electrically connected to the pressing rods, the alignment rod and the suction device.

The primary objective of the present invention is to provide a control device for directly controlling the pressing rods, the alignment rod and the suction device of the inkjet printing machine. By the control device, the user can control the above mentioned devices without frequent back-and-forth movement between the inkjet printing machine and the computer.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a front end of the inkjet printing machine of the present invention, and

FIG. 2 is a perspective view to show a rear end of the inkjet printing machine of the present invention.

### DETAILED DESCRIPTION OF THE PREFERRED EMBODIMENT

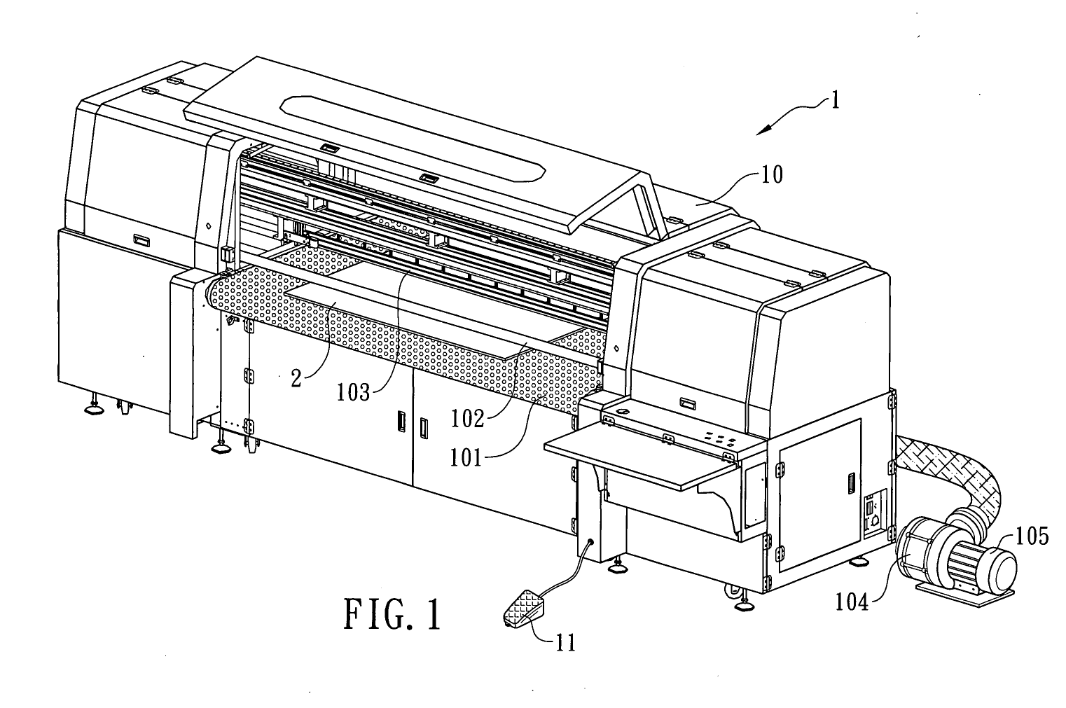

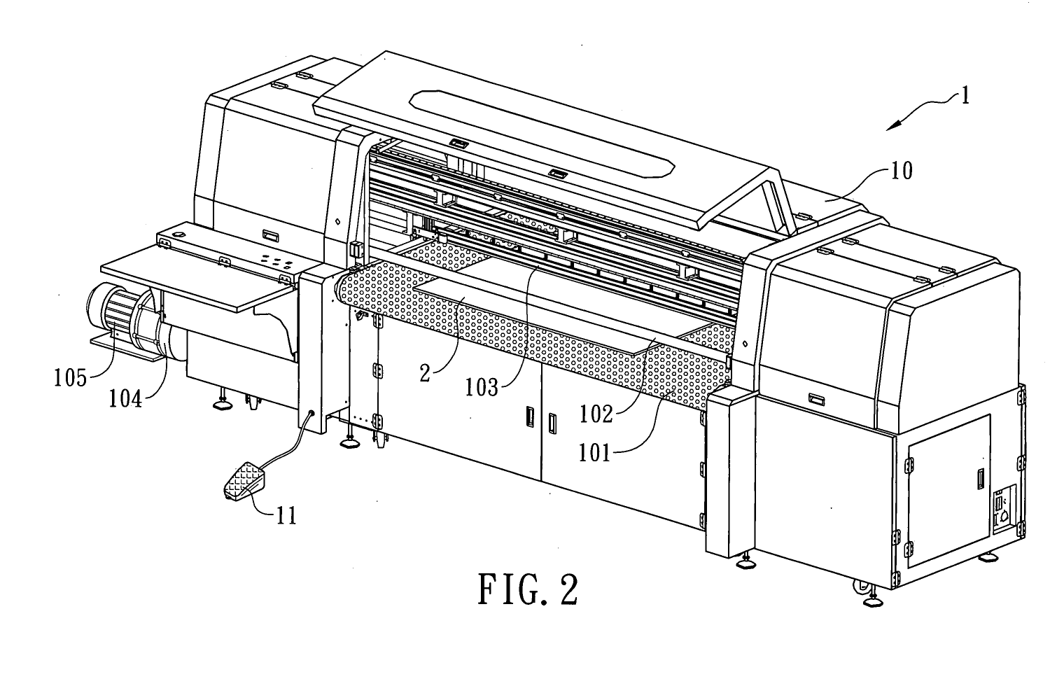

Referring to FIGS. 1 and 2, the inkjet printing machine 1 of the present invention comprises a main body 10 having a work surface 101 and a control device 11.

Two pressing rods 102 are movably located above the work surface 101, an alignment rod 103 is movably located a center of the work surface 101, and a suction device 104 located beneath the work surface 101 and includes holes defined through the work surface 101.

A motor 105 is connected with a hose which is connected to the suction device 104 so as to provide a vacuum suction force to suck the paper sheet 2 on the work surface 101. The two pressing rods 102 are located on a front end and a rear end of the work surface 101.

A control device 11 is connected to the main body 10 and includes two foot-control treadles 11 which are located at a front end of the main body 10 and a rear end of the main body 10. The control device 11 can also equipped with hand-control members (not shown) or foot-control members for convenience of operation. In the preferred embodiment, the control device 11 are two treadles electrically connected to the two pressing rods 102, the alignment rod 103 and the suction device 104.

When operating the inkjet printing machine 1, the user presses on either one of the treadles 11 to shut down the suction device 104, to raising the pressing rods 102 and to lower the alignment rod 103, a paper sheet 2 or any object to be printed is then put on the work surface 101. The paper sheet 2 is pressed by the lowered pressing rods 102 and aligns along the alignment rod 103. The treadles 11 are pressed again to activate the suction device 104 so as to suck the paper sheet 2 on the work surface 101. After the paper sheet 2 is set, the printing heads (not shown) are moved to print on the paper sheet 2.

Because the treadles 11 are located at the front end and the rear end of the main body 10 so that the user can directly input commands to control the pressing rods 102, the alignment rod 103 and the suction device 104 at either of the front end or the rear end of the main body 10. The user does not need to move back and forth between the inkjet printing machine 1 and the computer (not shown), which saves time and increases efficiency.

While we have shown and described the embodiment in accordance with the present invention, it should be clear to those skilled in the art that further embodiments may be made without departing from the scope of the present invention.

What is claimed is:

1. An inkjet printing machine comprising:
a main body having a work surface, two pressing rods movably located above the work surface, an alignment rod movably located a center of the work surface, a suction device located beneath the work surface and including holes defined through the work surface, and
a control device connected to the main body and electrically connected to the pressing rods, the alignment rod and the suction device.

2. The machine as claimed in claim 1, wherein the control device is a hand-control member.

3. The machine as claimed in claim 1, wherein the control device is a foot-control treadle.

4. The machine as claimed in claim 1, wherein the pressing rods are located respectively on a front end and a rear end of the work surface.

5. The machine as claimed in claim 1, wherein the control device includes two sets located respectively on a front end and a rear end of the work surface.
